(19) United States
(12) Patent Application Publication
(10) Pub. No.: US 2004/0258903 A1
(43) Pub. Date: Dec. 23, 2004

(54) Antiperspirant-treated underarm pad

(76) Inventor: Glen B. Eberle, Chester, NJ (US)

Correspondence Address: Kenneth P. Glynn, Esq., Glynn & Associates, P.C., 24 Mine Street, Flemington, NJ, 08822, US

(21) Appl. No.: 10/464,959

(22) Filed: Jun. 19, 2003

(51) Int. Cl. B32B 5/02

(52) U.S. Cl. 428/317.9; 428/316.6; 428/317.3; 428/311.51

(57) ABSTRACT

An antiperspirant containing underarm pad delivers antiperspirant to an underarm area and absorbs perspiration. The pad has at least one absorbent top layer, an antiperspirant active ingredient on or in the top layer, and an attachment mechanism, preferably an adhesive on the bottom. It is conveniently adhered to the inside underarm area of an upper torso garment, such as a shirt, blouse or tee shirt.

### BACKGROUND OF THE INVENTION

1. Field of the Invention

The present invention relates to underarm protection, and specifically to a device for both reducing perspiration and absorbing perspiration. Thus, the present invention is directed to an underarm pad adapted for attachment to clothing, that includes at least one antiperspirant.

2. Information Disclosure Statement

The following patents are representative of the prior art relating to absorbent pads:

U.S. Pat. No. 5,661,039 illustrates a method of screening for the presence of a bone resorption abnormality is disclosed. The method includes obtaining a sweat sample from the subject, and determining the level of native free pyridinoline (Pyd) and/or deoxypyridinoline (Dpd) in the sample. The determined level is compared with a predetermined level characteristic of normal subjects, and an above-normal level is an indication that the subject has a bone resorption abnormality.

U.S. Pat. No. 6,156,818 A present invention relates to disposable absorbent articles, particularly sanitary napkins, pantiliners, adult incontinence products, or baby diapers. In particular the present invention relates to such disposable absorbent articles with side cuffs which are maintained in their in-use position by direct attachment to the skin of the wearer. The topical adhesive attachment of such side cuffs needs to be secure and pleasing upon application and during use of such articles, yet cause no discomfort upon removal of the article. This is achieved by the present invention selecting the Theological characteristics of adhesives for such articles.

U.S. Pat. No. 6,187,989 The present invention relates to breathable absorbent articles particularly sanitary napkins, panty liners, adult incontinence products or sweat pads. In particular, the present invention relates to such breathable absorbent articles which are worn by direct attachment to the skin of the wearer in the area where absorption of bodily liquids is desired

U.S. Pat. No. 6,261,679 Disclosed is a fibrous absorbent structure that is wet stable and has large void volume with density below the critical density of the fiber employed. In one embodiment, the fibrous absorbent uses open-celled foam technologies to keep the fibrous structure expanded and bonded. In other embodiments, the resulting fibrous structure resembles an open-celled polymeric foam, with fibers serving as struts stabilized by binder material. In another embodiment, the resulting fibrous structure is filled with hydrophilic open-celled foams with the cell size substantially smaller than the fibrous pores. Such a wet-stable, high void volume fibrous absorbent can be used in a disposal product intended for the absorption of fluid such as body fluid, including extensible absorbent articles.

U.S. Pat. No. 6,316,524 The invention is a disposable absorbent article for topical adhesive attachment to a wearer. The article has a wearer facing surface and a garment facing surface and comprises an absorbent core. The article comprises an adhesive on at least the wearer facing surface. The adhesive has a dynamic elastic behaviour so that the difference between G′37 at a frequency of 1 rad/sec and G′37 at a frequency of 100 rad/sec is not greater than 150% of G′37 at a frequency of 1 rad/sec. The adhesive has a dynamic viscous behavior so that the difference between G″37 at a frequency of 1 rad/sec and G″37 at a frequency of 100 rad/sec is not greater than 10,000 Pa. The ratio G′37 over G″37 in the frequency range 1-100 rad/s is greater or equal to 3.3.

Notwithstanding the prior art, the present invention is neither taught nor rendered obvious thereby.

### SUMMARY OF THE INVENTION

The present invention relates to an antiperspirant-treated underarm pad that has been created to deliver antiperspirant to an armpit area and to absorb perspiration. The present invention pad includes a flexible underarm pad element adapted to be positioned at a human armpit. It has a top and a bottom, and has at least one absorbent layer located at the top. There is also at least one antiperspirant active ingredient contained within or on the absorbent pad element; i.e. the active ingredient is on the top of the device so as to sometimes contact the armpit area and rub or deliver antiperspirant thereto. Also, there is an attachment means connected to the pad element for attachment of the pad element to clothing in an armpit area. The attachment means could be any functional attachment means that would work, e.g. Velcro, but the preferred attachment means is adhesive. Optional peelable strip(s) could cover the adhesive until needed. The attachment means, e.g. the adhesive, is located on the bottom of the pad element.

The antiperspirant may be any available antiperspirant, in concentrate or diluted form. In some preferred embodiments, the antiperspirant may be aluminum zirconium chlorohydrate.

The antiperspirant-treated underarm pad of the present invention flexible pad element may include at least one absorbent layer selected from the group consisting of cotton, cellulosic fiber non-woven rayon, and combination thereof. Any other skin friendly absorbing material or combinations of materials could be used.

In some preferred embodiments, the present invention antiperspirant-treated underarm pad element further includes at least one sweat-impervious layer located at the bottom of the absorbent layer, and the attachment means is located on the bottom side of this sweat-impervious layer.

Optionally, in addition to antiperspirant, the antiperspirant-treated underarm pad may also include at least one deodorizing component. It may further include a scenting element.

### BRIEF DESCRIPTION OF THE DRAWINGS

The present invention should be more fully understood when the specification herein is taken in conjunction with the drawings appended hereto wherein:

FIG. 1 shows a top view,

FIG. 2 shows a side view and

FIG. 3 shows a bottom view of one preferred present invention antiperspirant-treated underarm pad embodiment;

FIG. 4 shows the above present invention pad in use, Attached to the inside armpit area of a shirt: and

FIGS. 5 and 6 show side views of two additional alternative embodiment present invention pads.

### DETAILED DESCRIPTION OF THE PRESENT INVENTION

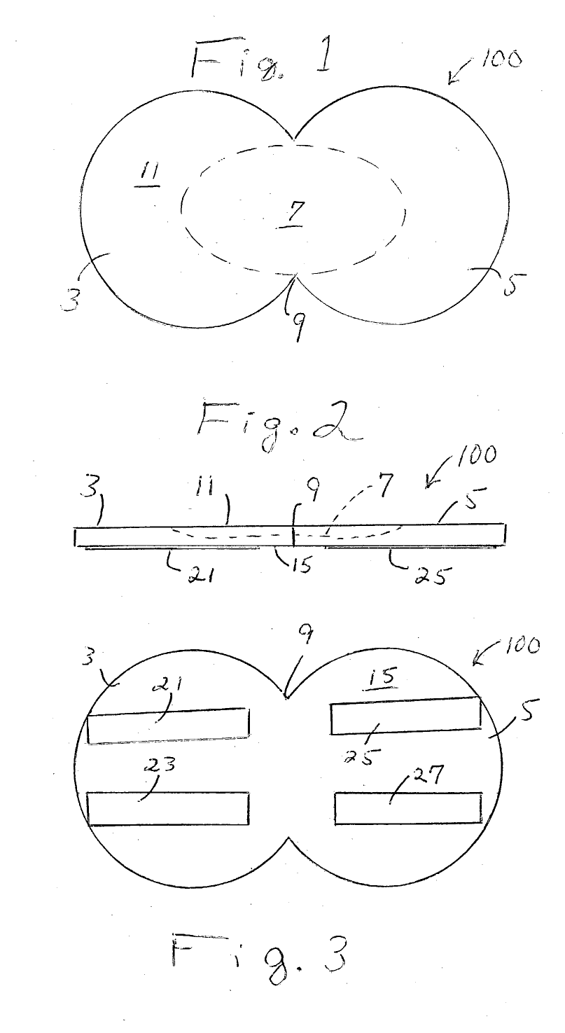

FIG. 1 shows a top view present invention antiperspirant-treated underarm pad 100. It includes a flexible pad element shown as top 11 with a pad element left portion 3 and a pad element right portion 5. In this embodiment, the pad element is an absorbent layer, such as a cotton layer. Alternatively, it could be a cellulosic fiber layer, combination of two or more of these in a single layer, or multiple layers of any of the forgoing. In center area 7 of top 11 is at least one antiperspirant active ingredient. Preferred is aluminum zirconium chlorohydrate. An effective amount is used, from a small fraction of a gram to a gram or more, depending upon the thickness and material of the absorbent layer, the area and the strength of the diluent.

In FIG. 1, the left portion 3 and the right portion 5 are 4/5 circles joining at a narrow central area 9. This central area 9 is the fold area, i.e. the part that folds over the armpit area of the shirt, tee shirt, or the like. While these joined circles are shown as one top view configuration of the present invention pad, other footprints could just as readily be useful, such as a rectangle, e.g. with rounded corners, or joined ovals, or any other reasonable shape that would fold at the sleeve/body joint of a shirt.

In FIG. 2, a side view of pad 100 from FIG. 1 is shown with identical parts identically numbered. Also, FIG. 2 shows bottom 15 with adhesive strips 21 and 25. These are the attachment means for attaching the pad to an inside armpit area of a garment.

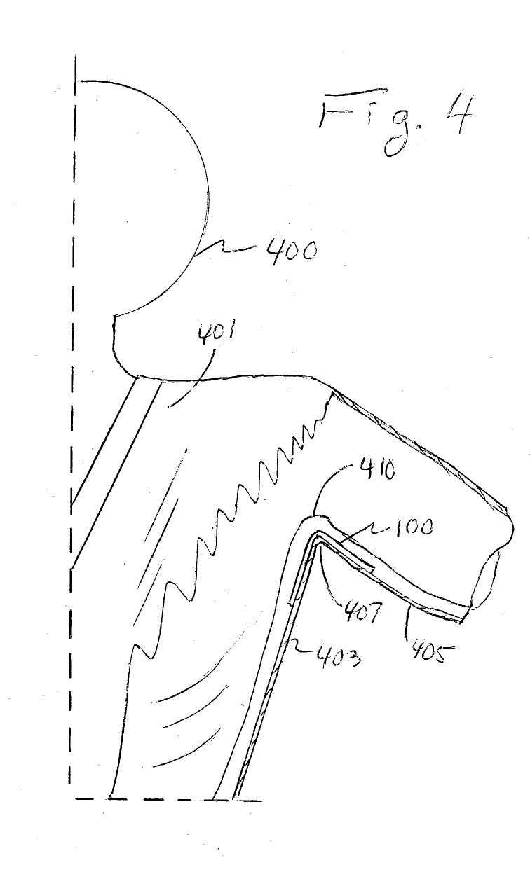

FIG. 3 shows a bottom view of the above-described present invention pad 100, again with identical parts identically numbered. Here, left portion 3 and right portion 5 at bottom 15 include pairs of adhesive strips 21 and 23, and 25, and 27, respectively.

FIG. 4 shows a partial front view of a stylized man with a tee shirt utilizing present invention pad 100 described above. In FIG. 4, stylized man 400 is wearing a casual shirt 401 that is shown partially cut. Right side panel 403 of shirt 401 and sleeve section 405 join at armpit junction 407. At junction 407 present invention pad 100 is attached to the side of right side panel 403, sleeve section 405, and armpit junction 406 at its bottom adhesive strips. In this position, present invention pad 100 both absorbs perspiration and delivers antiperspirant to armpit 410. It should now be clear that the present invention pads could be used with almost any armpit-hiding apparel, be it a shirt, a blouse, underwear top, jumpsuit, etc.

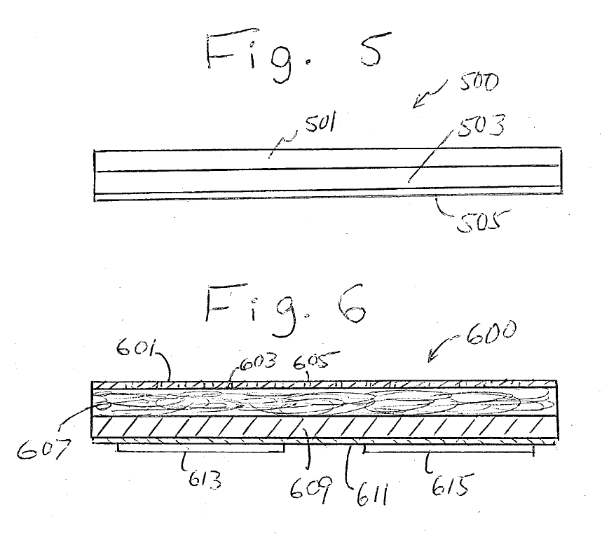

FIGS. 5 and 6 show alternative embodiment present invention pads. In FIG. 5, pad 500 includes a cotton layer 501, a cellulosic fiber layer 503 and an adhesive layer 505 on the underside.

FIG. 6 shows present invention device pad 600. It has a compact breathing fiber layer 601 with many pores (breathing orifices) such as pores 603 and 605. Layer 601 has been coated with an antiperspirant solution. Underneath layer 601 is a cotton batting layer 607. This layer absorbs perspiration. Below it is an impermeable layer 609 formed of a plastic film, followed by an underlayer 611 of fabric. Adhesive strips 613 and 615 are located on the underside of underlayer 611.

Pads 500 and 600, show in FIGS. 5 and 6 respectively, may be used in a manner similar to that illustrated in FIG. 4 above.

Obviously, numerous modifications and variations of the present invention are possible in light of the above teachings. It is therefore understood that within the scope of the appended claims, the invention may be practiced otherwise than as specifically described herein.

What is claimed is:

1. An antiperspirant-treated underarm pad, which comprises:
(a) a flexible underarm pad element adapted to be positioned at a human arm pit and having a top and a bottom, and having at least one absorbent layer located at said top;
(b) at least one antiperspirant active ingredient contained within or on said pad element; and,
(c) an attachment means connected to said pad element for attachment of said pad element to clothing in an armpit area.

2. The antiperspirant-treated underarm pad of claim 1 wherein said attachment means is an adhesive.

3. The antiperspirant-treated underarm pad of claim 2 wherein said adhesive is located on said bottom of said pad element.

4. The antiperspirant-treated underarm pad of claim 1 wherein said at least one antiperspirant includes aluminum zirconium chlorohydrate.

5. The antiperspirant-treated underarm pad of claim 1 wherein said flexible pad element includes at least one absorbent layer is selected from the group consisting of cotton, cellulosic fiber non-woven rayon, and combination thereof.

6. The antiperspirant-treated underarm pad of claim 1 wherein said pad element further includes at least one sweat-impervious layer located at said bottom.

7. The antiperspirant-treated underarm pad of claim 5 wherein said pad element further includes at least one sweat-impervious layer located at said bottom.

8. The antiperspirant-treated underarm pad of claim 6 wherein said attachment means is located on said at least one sweat-impervious layer.

9. The antiperspirant-treated underarm pad of claim 1 which further includes at least one deodorizing component.

10. The antiperspirant-treated underarm pad of claim 1 which further includes a scenting element.

11. An antiperspirant-treated underarm pad, which comprises:
(a) a flexible underarm pad element adapted to be positioned at a human arm pit and having a top and a bottom, and having at least one absorbent layer located at said top, said pad element having at least one upper layer and at least one lower layer wherein said at least one upper layer is an absorbent layer having a plurality of pores located thereon, said lower layer also being an absorbent layer.
(b) at least one antiperspirant active ingredient contained within or on said pad element; and,
(c) an attachment means connected to said pad element for attachment of said pad element to clothing in an armpit area.

12. The antiperspirant-treated underarm pad of claim 11 wherein said attachment means is an adhesive.

13. The antiperspirant-treated underarm pad of claim 12 wherein said adhesive is located on said bottom of said pad element.

14. The antiperspirant-treated underarm pad of claim 11 wherein said at least one antiperspirant includes aluminum zirconium chlorohydrate.

15. The antiperspirant-treated underarm pad of claim 11 wherein said flexible pad element includes at least one absorbent layer is selected from the group consisting of cotton, cellulosic fiber non-woven rayon, and combination thereof.

16. The antiperspirant-treated underarm pad of claim 11 wherein said pad element further includes at least one sweat-impervious layer located at said bottom.

17. The antiperspirant-treated underarm pad of claim 15 wherein said pad element further includes at least one sweat-impervious layer located at said bottom.

18. The antiperspirant-treated underarm pad of claim 16 wherein said attachment means is located on said at least one sweat-impervious layer.

19. The antiperspirant-treated underarm pad of claim 11 which further includes at least one deodorizing component.

20. The antiperspirant-treated underarm pad of claim 11 which further includes a scenting element.
